(19) United States
(12) Patent Application Publication
(10) Pub. No.: US 2016/0192147 A1
(43) Pub. Date: Jun. 30, 2016

(54) HEAT MAP GENERATION WITH PEER-TO-PEER MOBILE DEVICE NETWORK

(71) Applicant: QUALCOMM Incorporated, San Diego, CA (US)

(72) Inventors: Subash MARRI SRIDHAR, San Jose, CA (US); Sai Pradeep VENKATRAMAN, Santa Clara, CA (US); Praveen DUA, Cupertino, CA (US)

(21) Appl. No.: 14/864,766

(22) Filed: Sep. 24, 2015

Related U.S. Application Data
(60) Provisional application No. 62/099,058, filed on Dec. 31, 2014.

(51) Int. Cl. H04W 4/02; H04W 4/06; H04L 29/08

(52) U.S. Cl. CPC H04W 4/025; H04L 67/104; H04W 4/06

(57) ABSTRACT

Methods, systems, computer-readable media, and apparatuses are presented for excluding peer-to-peer mobile device signal data from a heat map. In response to receiving an identifier of a mobile device in a peer-to-peer network group, a server may generate resultant data by excluding data associated with a signal generated by the mobile device from data used to generate a heat map. The server can generate the heat map using the resultant data.

### CROSS-REFERENCES TO RELATED APPLICATIONS

This patent application claims priority to U.S. Provisional Patent Application Ser. No. 62/099,058, filed Dec. 31, 2014, entitled “Heat Map Generation with Peer-to-Peer Mobile Device Network and Mobile Device Tracking with Peer-to-Peer Mobile Device Network,” the content of which is incorporated herein by reference in its entirety for all purposes.

### BACKGROUND

Aspects of the present disclosure relate to identifying a group owner mobile device in a peer-to-peer network of mobile devices to improve heat map generation.

Further aspects of the disclosure relate to identifying client mobile devices associated with a group owner mobile device in a peer-to-peer network group of mobile devices to improve mobile device tracking.

Mobile device positioning may be performed using access points (APs) that each measure a signal generated by the mobile device and report information associated with the mobile device signal to a positioning server. Alternatively, a mobile device may measure signals from multiple APs and report data associated with the APs to a positioning server. The positioning server can determine the position of a mobile device by comparing signals measured by the mobile device or by the APs to a heat map that provides expected signal strengths, e.g., received signal strength indicator RSSI), or signal propagation delay, e.g., return trip time (RTT), for the multiple APs at various positions in an environment.

In a peer-to-peer (P2P) network of mobile devices, such as a network established in accordance with the Wi-Fi Direct standard, mobile devices may broadcast signals to enable communication among peers of the network. The broadcast signals may be detected along with signals generated by APs when data is being gathered for generating a heat map.

Reducing potentially less useful data when generating heat maps may be desirable for improving the quality of the heat maps.

When a large number of mobile devices are located in an environment, reducing the frequency of tracking the location of the mobile devices may also be desirable.

### BRIEF SUMMARY

Certain aspects of the present disclosure relate to excluding mobile device data from data used to generate a heat map.

In one example, a method for generating a heat map is presented. The method includes receiving data for generating the heat map and receiving an identifier of a first mobile device in a peer-to-peer network group. In response to receiving the identifier of the first mobile device, resultant data is generated by excluding data associated with a signal generated by the first mobile device from the data for generating the heat map, and the heat map is generated using the resultant data.

In some embodiments, the first mobile device of the method for generating the heat map is a group owner of the peer-to-peer network group. The group owner supports at least one of communications between devices within the peer-to-peer network group or communications between a device within the peer-to-peer network group and devices outside of the peer-to-peer network group. For example, the group owner may serve as an access point for the peer-to-peer network group.

The identifier of the first mobile device may be included in a broadcast data from the first mobile device. For example, at least a part of the identifier of the first mobile device may be included in a peer-to-peer network information element of the broadcast data from the first mobile device. The identifier of the first mobile device may include a media access control (MAC) address.

The method for generating a heat map may also include receiving an identifier of a second mobile device in the peer-to-peer network group, and, in response to receiving the identifier of the second mobile device, generating the resultant data by excluding data associated with a signal generated by the second mobile device from the data for generating the heat map. The method may also include requesting the identifier of the second mobile device from the first mobile device, and receiving data from the first mobile device including the identifier of the second mobile device. Alternatively, receiving the identifier of the second mobile device may include receiving the identifier of the second mobile device from the first mobile device without a request. The identifier of the second mobile device may include a media access control (MAC) address.

The data for generating the heat map may include data associated with signals generated by a plurality of access points, wherein the data is determined for a plurality of locations in an environment. The data for generating the heat map may also include received signal strength indicator (RSSI) data or round trip time (RTT) data.

In another example, a server is presented. The server includes a processor and a computer readable storage device coupled to the processor. One or more programs are stored in the computer readable storage device and configured to be executed by the processor. The one or more programs include instructions for receiving data for generating a heat map and receiving an identifier of a first mobile device in a peer-to-peer network group. In response to receiving the identifier of the first mobile device, data associated with a signal generated by the first mobile device is excluded from data for generating a heat map. The heat map is generated using the resultant data with data associated with the signal generated by the first mobile device excluded.

In an additional example, a non-transitory computer readable medium is presented. The non-transitory computer readable medium includes machine-readable instructions stored thereon for generating a heat map. The instructions include instructions for receiving data for generating the heat map and receiving an identifier of a first mobile device in a peer-to-peer network group. In response to receiving the identifier of the first mobile device, data associated with a signal generated by the first mobile device is excluded from data used to generate the heat map. The heat map is generated using the resultant data with data associated with the signal generated by the first mobile device excluded.

In a further example, an apparatus for generating a heat map is disclosed. The apparatus for generating the heat map includes means for receiving data for generating the heat map; means for receiving an identifier of a first mobile device in a peer-to-peer network group; means for, in response to receiving the identifier of the first mobile device, excluding data associated with a signal generated by the first mobile device from the data for generating the heat map; and means for generating the heat map using the resultant data.

Certain aspects are described for determining positions of client mobile devices in a peer-to-peer network.

In one example, a method for determining a position of a client mobile device in a peer-to-peer network group is presented. The method includes determining a position of a group owner mobile device of the peer-to-peer network group. The group owner mobile device supports at least one of communications between devices within the peer-to-peer network group or communications between a device within the peer-to-peer network group and devices outside of the peer-to-peer network group. The group owner mobile device may serve as an access point for the peer-to-peer network group. The method further includes receiving information about a distance between the group owner mobile device and the client mobile device. It is also determined whether the distance between the group owner mobile device and the client mobile device exceeds a threshold distance. Based on a determination that the distance between the group owner mobile device and the client mobile device does not exceed the threshold distance, the position of the client mobile device is determined to be the position of the group owner mobile device.

The distance between the group owner mobile device and the client mobile device may be measured using a round trip time (RTT). Determining the position of the group owner mobile device may include receiving a round trip time (RTT) between the group owner mobile device and each access point of a plurality of access points. Alternatively, determining the position of the group owner mobile device may include receiving received signal strength indicator (RSSI) data of signals associated with a plurality of access points. The RSSI data may be measured by the group owner mobile device. In some embodiments, determining the position of the group owner mobile device may include obtaining a heat map and determining the position of the group owner mobile device using the heat map.

If the distance between the group owner mobile device and the client mobile device exceeds the threshold distance, the position of the client mobile device may be determined. For example, determining the position of the client mobile device may include receiving a round trip time (RTT) between the client mobile device and each access point of a plurality of access points. As another example, determining the position of the client mobile device may include receiving received signal strength indicator (RSSI) data of signals associated with a plurality of access points, where the RSSI data may be measured by the client mobile device. In some embodiments, determining the position of the client mobile device may include obtaining a heat map and determining the position of the client mobile device using the heat map.

The method for determining a position of a client mobile device in a peer-to-peer network group may further include receiving an identifier of the group owner mobile device and an identifier of the client mobile device. In some embodiments, at least one of the identifier of the group owner mobile device or the identifier of the client mobile device includes a media access control (MAC) address. In some embodiments, at least one of the identifier of the group owner mobile device, the identifier of the client mobile device, or the distance between the group owner mobile device and the client mobile device is received in a beacon signal from the group owner mobile device. In some embodiments, at least one of the identifier of the group owner mobile device, the identifier of the client mobile device, or the distance between the group owner mobile device and the client mobile device is included in an extended peer-to-peer information element of the beacon signal.

In another example, a server is presented. The server includes a processor and a computer readable storage device coupled to the processor. One or more programs are stored in the computer readable storage device and configured to be executed by the processor. The one or more programs include instructions for determining a position of a group owner mobile device of a peer-to-peer network group. The group owner mobile device supports at least one of communications between devices within the peer-to-peer network group or communications between a device within the peer-to-peer network group and devices outside of the peer-to-peer network group. The one or more programs further include instructions for receiving information about a distance between the group owner mobile device and a client mobile device in the peer-to-peer network group. The one or more programs further include instructions for determining whether the distance between the group owner mobile device and the client mobile device exceeds a threshold distance. Based on a determination that the distance between the group owner mobile device and the client mobile device does not exceed the threshold distance, the server determines the position of the client mobile device to be the position of the group owner mobile device.

In an additional example, a non-transitory computer readable medium is presented. The non-transitory computer readable medium includes instructions stored thereon for determining a position of a client mobile device in a peer-to-peer network group. The instructions include instructions for determining a position of a group owner mobile device of the peer-to-peer network group. The group owner mobile device supports at least one of communications between devices within the peer-to-peer network group or communications between a device within the peer-to-peer network group and devices outside of the peer-to-peer network group. The instructions also include instructions for receiving information about a distance between the group owner mobile device and the client mobile device. The instructions further include instructions for determining whether the distance between the group owner mobile device and the client mobile device exceeds a threshold distance. Based on a determination that the distance between the group owner mobile device and the client mobile device does not exceed the threshold distance, the position of the client mobile device is determined to be the position of the group owner mobile device.

In another example, an apparatus for determining a position of a client mobile device in a peer-to-peer network group is presented. The apparatus includes means for determining a position of a group owner mobile device of the peer-to-peer network group. The group owner mobile device supports at least one of communications between devices within the peer-to-peer network group or communications between a device within the peer-to-peer network group and devices outside of the peer-to-peer network group. The apparatus also includes means for receiving information about a distance between the group owner mobile device and the client mobile device. The apparatus further includes means for determining whether the distance between the group owner mobile device and the client mobile device exceeds a threshold distance, and means for determining the position of the client mobile device to be the determined position of the group owner mobile device if the distance between the group owner mobile device and the client mobile device does not exceed the threshold distance.

### BRIEF DESCRIPTION OF THE DRAWINGS

Aspects of the present disclosure are illustrated by way of example. In the accompanying figures, like reference numbers indicate similar elements.

FIG. 1 illustrates an example of a P2P network group that may be established among mobile devices.

FIG. 2 illustrates an example of a wireless local area network (WLAN) that may communicate with a P2P network group.

FIG. 3 illustrates an example of a positioning network.

FIG. 4A illustrates a heat map for an environment.

FIG. 4B illustrates another heat map for an environment, according to an embodiment.

FIG. 5 is an illustrative sequence diagram for establishing a P2P network group and identifying client devices of the P2P network group to a server, according to an embodiment.

FIG. 6A illustrates a flow chart for excluding data associated with mobile P2P network signal sources from a heat map, according to an embodiment.

FIG. 6B illustrates a flow chart for excluding data associated with mobile P2P network signal sources from a heat map, according to another embodiment.

FIG. 7A illustrates a flow chart for determining positions of mobile devices in a P2P network group, according to an embodiment.

FIG. 7B illustrates a flow chart for determining a position of a mobile device in a P2P network group, according to an embodiment.

FIG. 8 illustrates an example of a computer system in which one or more embodiments may be implemented.

FIG. 9 illustrates an example of a mobile device, according to some embodiments.

### DETAILED DESCRIPTION

Several illustrative embodiments will now be described with respect to the accompanying figures, which form a part hereof. While particular embodiments, in which one or more aspects of the disclosure may be implemented, are described below, other embodiments may be used and various modifications may be made without departing from the spirit of the disclosure or the scope of the appended claims.

Peer-to-peer (P2P) network technology can be used to implement various improvements to mobile device positioning systems. For example, when a positioning server is tracking mobile device positions in an environment with a large number of mobile devices, it may be resource intensive for the positioning server to compute position information for each mobile device. To conserve resources associated with mobile device tracking, a server may determine whether to assign a position of a group owner mobile device in a P2P network group to one or more client mobile devices in the P2P network group.

A mobile device in a P2P network, such as a group owner mobile device, may broadcast a beacon signal similar to a beacon signal transmitted by an access point in a wireless local area network. When the beacon signal is collected for generating a heat map, a group owner beacon may be detected when data from AP beacons is being gathered. However, because the group owner mobile device is unlikely to maintain a stable position, it may be preferable to exclude group owner beacon data from heat maps. A group owner mobile device may transmit data allowing a position server to identify beacon data originating from mobile device sources. The server can use this information to exclude or remove mobile device beacon data from heat maps.

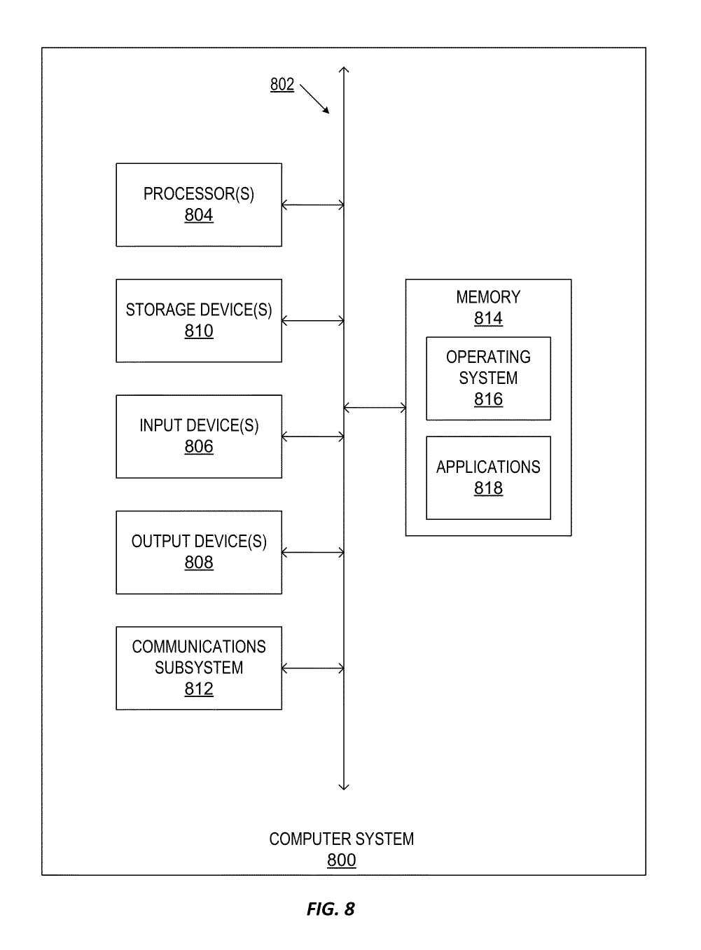

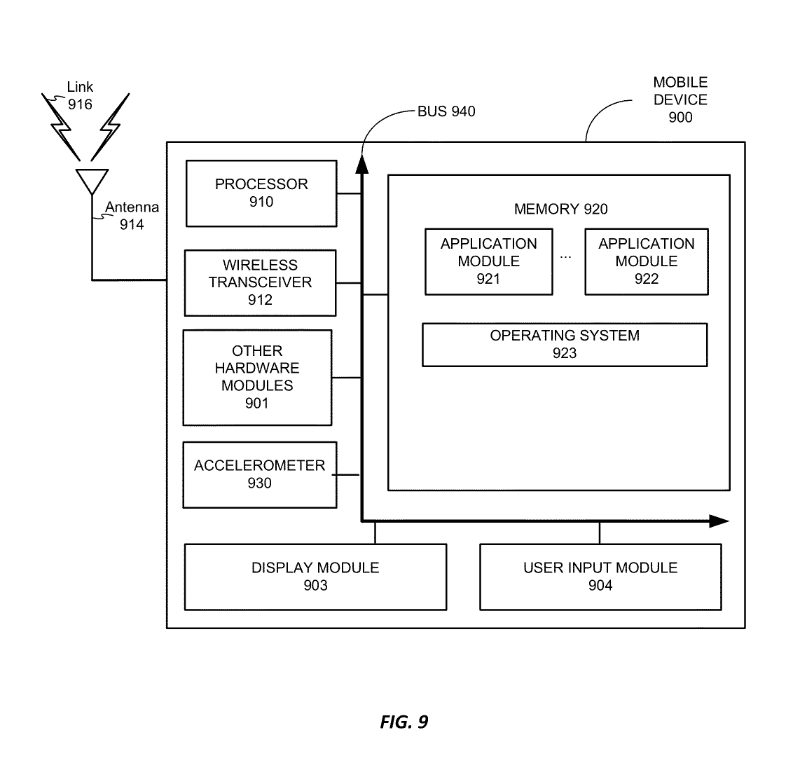

As used herein, “mobile device” may refer to any mobile electronic computing device. Examples of mobile devices may include smartphones, laptop computers, portable gaming systems, specialized electronic devices for positioning, or any other such electronic device. Additional examples of mobile devices and computing devices may be disclosed in relationship to FIGS. 8-9 below.

As used herein, “peer-to-peer network” (“P2P network”) refers to a network in which mobile devices may be enabled to exchange information with other devices, including other mobile devices. In some embodiments, a P2P network may be an ad-hoc network established according to a protocol described in Wi-Fi Direct® standard by the Wi-Fi alliance (e.g., Wi-Fi Peer-to-Peer (P2P) Technical Specification v.14). The P2P network may be built upon the Institute of Electrical and Electronics Engineers (IEEE) standard 802.11 infrastructure. A P2P network group may include a group owner mobile device and at least one client mobile device.

As used herein, “group owner” refers to a device that may support at least one, or both, of communications between devices within a P2P network group or communications between a device within the P2P network group and devices outside of the P2P network group. For example, a group owner may serve as a central point of communication for devices within a P2P network group to communicate with other devices within or outside of the P2P network group. In some embodiments, a group owner may operate as an access point for a P2P network group. In some embodiments, a group owner may perform at least some functions of an access point. In some embodiments, a group owner may perform a defined role in a P2P network group, the role including one or more tasks such as, for example, broadcasting a beacon signal to indicate status as a group owner in the P2P network group, providing clients with Internet Protocol (IP) addresses (e.g., by running a Dynamic Host Configuration Protocol (DHCP) server that provides the IP addresses), providing connections between client mobile devices of the P2P network group and external networks, such as a wireless local area network (WLAN), etc. A group owner may be selected by negotiation between mobile devices when a peer-to-peer network is being established among the mobile devices. In some embodiments, a group owner may alternate between group owner and client roles. The term “group owner” may be used to refer to a “group owner mobile device.”

As used herein, “client mobile device” refers to a mobile device in a P2P network group that is not a group owner. At least one client device may be determined at the time that a P2P network group is established. Additional client devices may join an established P2P network group.

As used herein, “access point” (AP) refers to a device connected as part of a wireless local area network (WLAN). Such a network may provide wireless access to a broader network using a particular wireless networking protocol such as an IEEE 802.11 protocol, Bluetooth, or any other wireless communication method. An AP may periodically transmit a beacon signal.

As used herein, “beacon” refers to a periodically transmitted frame that announces the presence of a network. For example, a group owner may transmit a beacon announcing the presence of a P2P network group. An AP may transmit a beacon announcing the presence of a WLAN network. A beacon may be transmitted at a predetermined interval. A beacon may include identification information associated with the device from which the beacon originated, such as media access control (MAC) address of the device.

As used herein, “received signal strength indicator” (RSSI) may refer to strength of a signal transmitted from an AP, mobile device, or other signal source. An RSSI emitted by one device may be measured by another device. For example, a mobile device may measure an RSSI of a signal emitted by an AP. Alternatively, an RSSI may be estimated at a particular location. For example, a server can use a known location and known signal strength of an AP to estimate RSSI levels at various points relative to the AP.

As used herein, “round trip time” (RTT) may be an amount of time needed for a signal to travel from a first node to a second node of a network and for an acknowledgement of the signal to be transmitted from the second mode to the first node. For example, an RTT may be an amount of time during which a signal is transmitted from a mobile device to an AP and during which the mobile device receives an acknowledgement from the AP that the signal was received. In another example, an RTT may be an amount of time during which a signal is transmitted from a group owner mobile device to a client mobile device and during which the group owner mobile device receives an acknowledgement from the client mobile device that the signal was received. RTT may be determined by an AP, a mobile device, or other device capable of transmitting and receiving signals. A server may determine RTT using data provided to the server, e.g., from a mobile device or AP.

As used herein, “position data” may include any data associated with a signal originating from a signal source device as measured or observed by another device. Position data may include RSSI, RTT, and other data. Position data may additionally include a determined location of a mobile device. For example, position data may be location coordinates or other indication of a position of a mobile device.

As used herein, “heat map” refers to a map of an environment that indicates signal strengths for signal sources detectable in the environment. The signal strengths may be, e.g., RSSI values. The signal strengths may be measured signal strengths or estimated signal strengths. The environment may be an indoor or outdoor environment, such as a room, set of rooms, building, section of a building, shopping mall, airport, sports arena, educational campus, commercial campus, convention center, and the like.

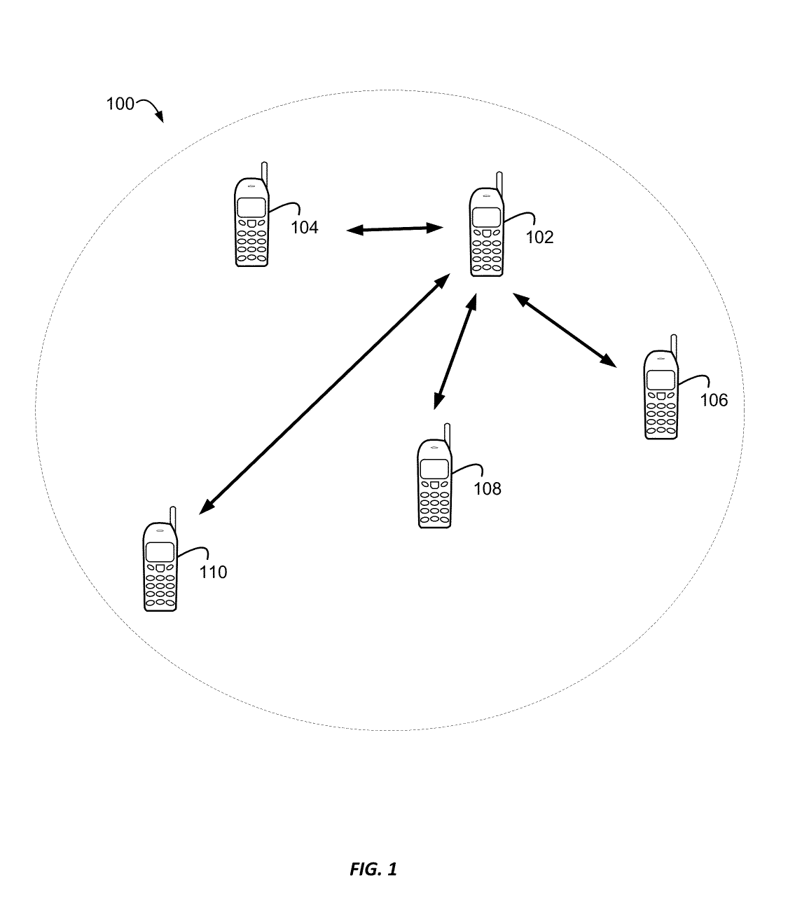

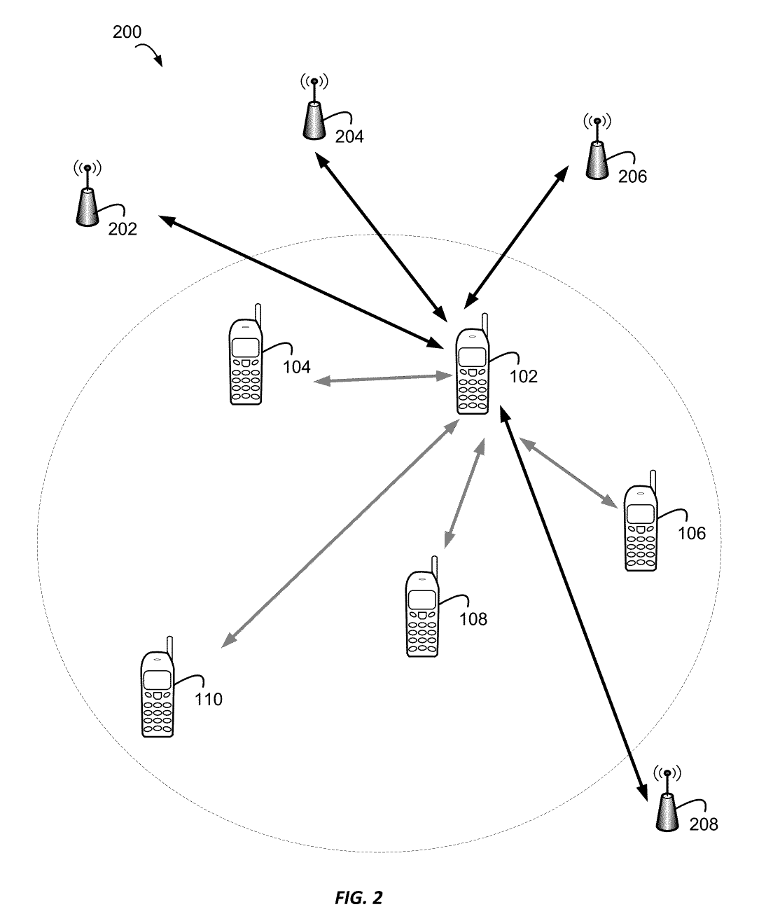

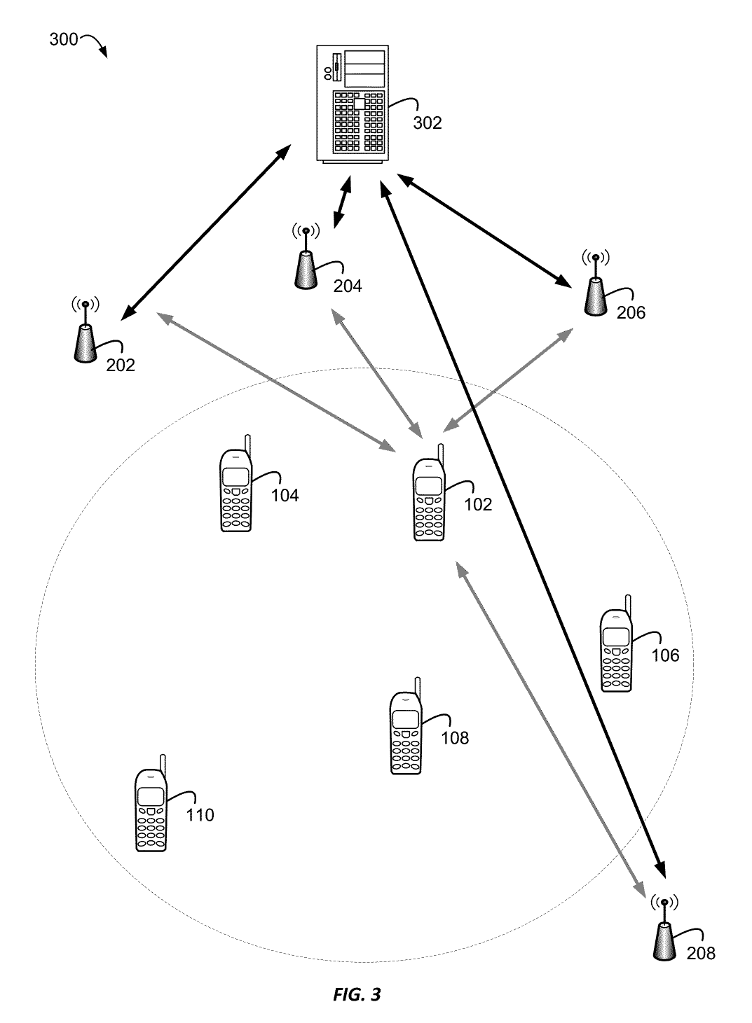

Embodiments described herein may be implemented using any P2P network such as the P2P network described with regard to FIG. 1. FIG. 2 illustrates a Wi-Fi network that may communicate with a P2P network. FIG. 3 illustrates a positioning network that may incorporate elements of a P2P network as described with regard to FIG. 1 and a Wi-Fi network as described with regard to FIG. 2.

FIG. 1 illustrates an example of a P2P network group 100 that may be established among mobile devices. P2P network group 100 may include a group owner mobile device 102 and one or more client mobile devices 104-110. P2P network group 100 may be established conforming to a standardized protocol, such as a protocol defined by a Wi-Fi Direct® specification.

When two or more mobile devices, such as mobile devices 102-110, discover each other, for example, via a Wi-Fi scan, the mobile devices may negotiate roles including a group owner role to establish P2P network group 100. After P2P network group 100 has been established, additional client mobile devices may join the group.

In some embodiments mobile device 102 may be selected as group owner based on particular capabilities of mobile device 102. For example, mobile device 102 may have RTT measurement capabilities (e.g., software for performing RTT measurements) not possessed by one or more other mobile devices in P2P network group 100. In another example, mobile device 102 may be more suitable for heavy data and/or power usage than one or more other mobile devices in P2P network group 100.

Group owner 102 may announce itself using a beacon. The group owner beacon may include data including identification information, such as a MAC address associated with the group owner. The group owner beacon may include a P2P information element (IE) that is specific to a particular P2P network protocol. In some embodiments, P2P IE received as part of a beacon frame may be in a type-length-value (TLV) format. A section in the frame, for example, at the end of the frame, may include an ID identifying that a given IE is a vendor-specific element. A particular identification (ID), such as a P2P IE, adopted by some conventions, such as IEEE 802.11-2007, and located in the vendor-specific element can indicate that the device broadcasting the beacon is acting as a group owner. The group owner's MAC address may also be found in the beacon. Using the particular ID and the group owner's MAC address in the beacon, the device with a MAC address matching the group owner's MAC address in the beacon may be identified as the group owner of the P2P network.

In some embodiments, a P2P IE may be extended to include additional information. For example, a proprietary communication framework may be established on top of a particular P2P network protocol. The proprietary communication framework may add information to a P2P IE as established by the P2P network protocol. The additional information may include identification information associated with one or more client mobile devices 104-110 in P2P network group 100.

When group owner 102 leaves P2P network group 100, a new group owner may be negotiated by the remaining mobile devices 104-110 in the group.

P2P network group 100 may communicate with a wireless local area network (WLAN), such as a Wi-Fi network. For example, when a positioning server determines a position for one or more mobile devices 102-110 in P2P network group 100, the positioning server may receive data from one or more mobile devices 102-110 via APs of a WLAN.

FIG. 2 illustrates an example of a WLAN 200 that may communicate with P2P network group 100. WLAN 200 includes APs 202-208.

APs 202-208 may communicate with mobile devices 102-110 using a WLAN connectivity, such as Wi-Fi and the like, or other wireless connectivity. In some embodiments, APs 202-208 communicate with group owner 102 to receive data associated with mobile devices 102-110 of P2P group 100. For example, identification information associated with group owner mobile device 102 and client mobile devices 104-110 may be determined from information provided by group owner mobile device 102.

FIG. 3 illustrates an example of a positioning network 300. Positioning network 300 may include a positioning server 302; a plurality of mobile devices, such as mobile devices 102-110, which may be components of P2P network group 100; and a plurality of APs, such as APs 202-208, which may be components of WLAN 200.

Server 302 may comprise one or more computing devices capable of processing location data and determining a position of a mobile device, such as mobile device 102. Server 302 may access data from a database (not shown). The database may be stored on one or more computing devices of server 302, or may be stored on one or more devices that are remote from and communicatively coupled to server 302. Server 302 may be located on site in an area for which position data is being provided, or may be located remotely from such an area.

Access points 202-208 may be communicatively coupled to server 302 and any other available infrastructure computing devices by wired or wireless connections.

Positioning network 300 may be used to determine a position for one or more mobile devices 102-110. APs (e.g., APs 202-208) of WLAN 200 may determine position data associated with mobile devices 102-110, for example, by measuring RSSI of signals transmitted by mobile devices 102-110 or by performing RTT measurements via communications with mobile devices 102-110. APs (e.g., APs 202-208) of WLAN 200 may transmit the position data to server 302. Server 302 may use received position data to estimate a distance between a mobile device (e.g., mobile device 102) and multiple APs (e.g., APs 202-208). Server 302 may use the estimated distances and known locations to perform trilateration or other position analysis techniques to estimate the position of mobile device 102. Server 302 may provide position data indicating the position of mobile device 102 to mobile device 102. For example, server 302 may transmit location coordinates of mobile device 102 to mobile device 102.

In a second illustrative example of positioning performed by positioning network 300, a mobile device (e.g. mobile device 102) may receive and/or observe position data from multiple APs (e.g. APs 202-208), which may be at known locations. Position data received and/or observed by mobile device 102 from the multiple APs may include, for example, RSSI and RTT. Mobile device 102 may provide the received and/or observed position data to server 302. Server 302 may use the position data to estimate a distance between mobile device 102 and the multiple APs (e.g. APs 202-208). Server 302 may compare the position data to a heat map that provides expected signal strengths for the multiple APs (e.g., APs 202-208) at various positions in an environment. Using the heat map and the position data, server 302 may determine the location of mobile device 102, for example, using pattern matching or another analysis technique. For example, pattern matching may include finding location coordinates at which RSSIs for the multiple APs (e.g., APs 202-208) as determined from a heat map most closely match the RSSIs observed by mobile device 102.

In some embodiments, a mobile device (e.g. mobile device 102) may determine its own position. A mobile device may receive and/or observe position data from multiple APs (e.g., APs 202-208), which may be at known locations. Position data received and/or observed by mobile device 102 from the multiple APs may include, for example, RSSI and RTT. Mobile device 102 may receive a heat map, e.g., from server 302. Mobile device 102 may use the heat map and the position data to determine the location of mobile device 102, for example, using pattern matching or another analysis technique. For example, pattern matching may include finding location coordinates at which RSSIs for the multiple APs (e.g., APs 202-208) as determined from a heat map most closely match the RSSIs observed by mobile device 102.

In some embodiments, server 302 may determine a position of a client mobile device, such as client mobile device 106, to be the same position as is determined for group owner device 102. For example, if a client mobile device (e.g., client mobile device 106) is within a predefined distance of group owner device 102, server 302 may determine the position of the client mobile device to be the same position as is calculated for group owner device 102. If a client mobile device (e.g., client mobile device 110) is beyond the predefined distance of group owner device 102, server 302 may calculate the position of the client mobile device in addition to calculating the position of group owner device 102.

When server 302 determines the position of client mobile device 106 to be the same position as is calculated for group owner device 102, it is not necessary for APs 202-208 to determine position data associated with client mobile device 106. In this way, server 302 reduces the amount of data reception and transmission and the amount of processing for tracking mobile devices, as server 302 no longer receives position data from mobile device 106 or calculate a position for client mobile device 106.

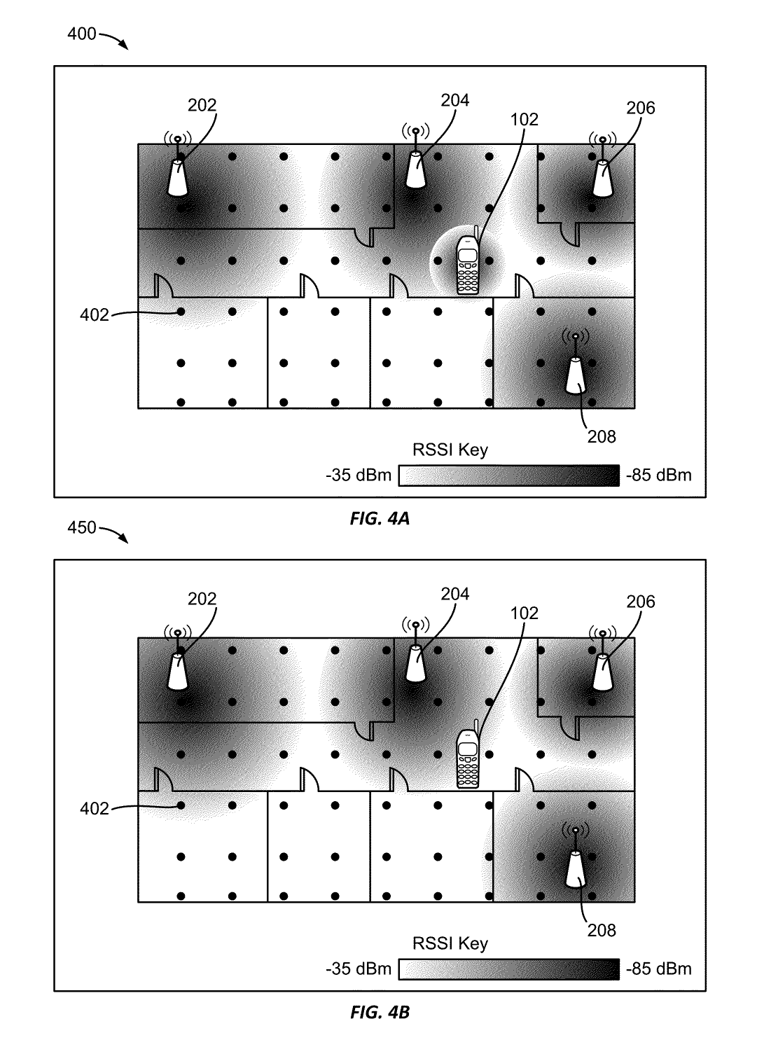

FIGS. 4A-4B are illustrative heat maps for an environment, according to various embodiments. Heat map 400 of FIG. 4A illustrates the strength of signals generated by APs 202-208 and group owner mobile device 102 as measured (or otherwise determined) at multiple locations associated with an environment. Heat map 450 of FIG. 4B illustrates, for the same environment shown in FIG. 4A, the strength of signals generated by APs 202-208 as measured (or otherwise determined) at multiple locations associated with the environment.

Heat map information corresponding to signal sources, such as APs 202-208 may be collected using different techniques. For example, a dedicated device may be used to measure signal strength at multiple locations within an environment. The locations may be regularly space grid points, such as grid points that are two feet apart. At a location, such as grid point 402, the dedicated device may send, for each signal source, the measured signal strength data (e.g., RSSI of a beacon signal) and signal source identifier (e.g., MAC address) to a server 302. Server 302 may store the heat map for use in mobile device positioning. In some embodiments, server 302 may send heat map data to a mobile device, such as mobile device 102, for use by mobile device 102 in determining its position.

In some embodiments, a crowd-sourcing scheme may be used to generate heat map information. For example, a plurality of mobile devices 102-110 may participate in crowd sourcing. The participating mobile devices may receive and/or observe position data, such as RSSI and/or RTT, from signal sources such as APs 202-208. The participating mobile devices may transmit the position data to server 302. Server 302 may use the received position data to generate a heat map. For example, server 302 may determine an estimated signal strength corresponding to each signal source at multiple locations (e.g., multiple regularly-spaced grid points 402) in an environment.

A beacon signal from group owner mobile device 102 may be detected when beacon signals of APs 202-208 are being measured. As indicated in the illustrative heat map of FIG. 4A, the beacon signal from group owner mobile device 102 may be measured at the time when beacon signals from APs 202-208 are measured for heat map generation. Heat map 400 generated based on the measured data may include signal data from group owner mobile device 102. However, as a mobile device rather than a stationary device, group owner mobile device 102 is more likely to move within or exit the environment shown in FIGS. 4A-4B than being at a fixed location. As a result, signals generated by group owner mobile device 102 in the environment may change with the movement of group owner mobile device 102 from time to time, and may be unstable. Thus, it may be preferable to exclude signal data associated with group owner mobile device 102 from the heat map to improve the reliability of heat map 400.

Heat map 450 of FIG. 4B shows a heat map generated when signal data associated with a signal produced by group owner mobile device 102 is excluded from the heat map. Position data associated with a signal produced by group owner mobile device 102 may be removed from heat map 400 to produce heat map 450. Alternatively, group owner mobile device 102 may be identified in a memory of server 302 such that position data associated with a signal produced by group owner mobile device 102 is excluded at the time that heat map 450 is generated by server 302.

In some embodiments, one or more client mobile devices 104-110 may generate signals that are detected when beacon signals of APs 202-208 are being measured. To avoid inclusion in a heat map of data associated with signals generated by client mobile devices 104-110, group owner mobile device 102 may provide identification information associated with client mobile devices 104-110 in P2P network group 100 to server 302. In this manner, when server 302 is generating a heat map, server 302 can avoid including signals associated with group owner mobile device 102 and client mobile devices 104-110 in the heat map data.

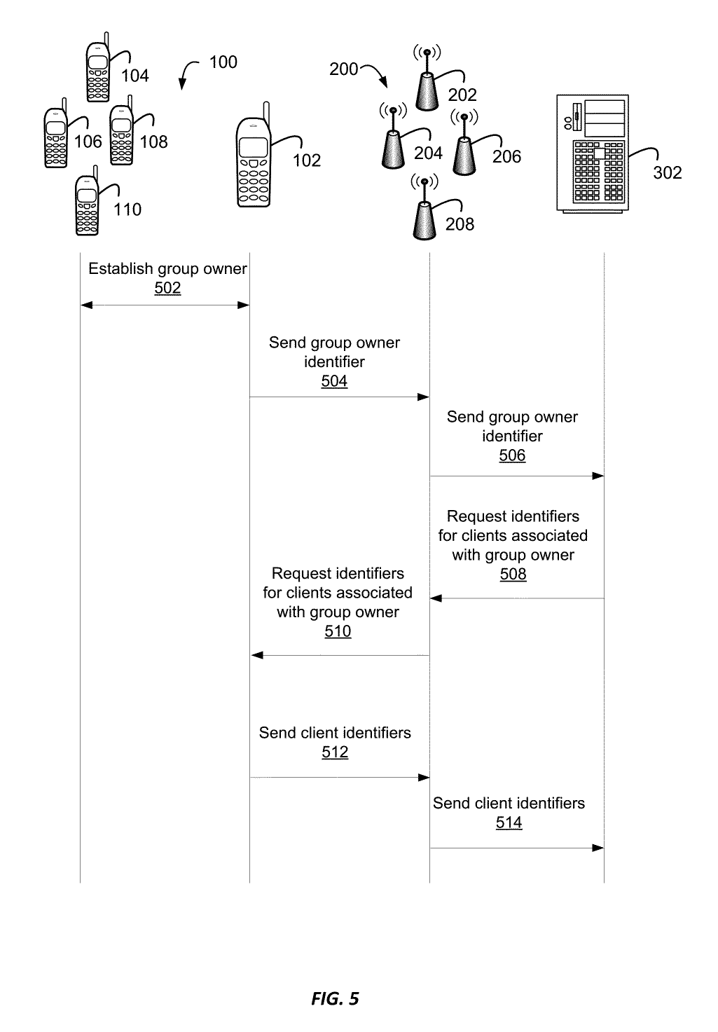

FIG. 5 is an illustrative sequence diagram for establishing a P2P network group and identifying client devices of the P2P network group to a server, according to an embodiment.

At operation 502, multiple mobile devices, such as mobile devices 102-110, may negotiate roles to determine group owner mobile device 102 of a P2P network group 100.

In an alternative embodiment, a mobile device may autonomously create a P2P network group 100 and become a group owner mobile device by broadcasting a group owner beacon. Client mobile devices may then joint P2P network group 100 established by the group owner mobile device.

At operation 504, group owner mobile device 102 may broadcast a beacon signal including a P2P IE. The P2P IE may include identification information (e.g., a MAC address) for group owner mobile device 102. One or more APs 202-208 of WLAN 200 may receive the beacon signal broadcast by group owner mobile device 102.

At operation 506, one or more APs 202-208 of WLAN 200 may transmit data including the identification information for group owner mobile device 102 to server 302.

At operation 508, server 302 may transmit to WLAN 200 a request for identifiers of client mobile devices associated with group owner mobile device 102.

At operation 510, group owner mobile device 102 may receive the request indicated at operation 508 from one or more APs 202-208 of WLAN 200.

At operation 512, group owner mobile device 102 may transmit a signal including identifiers (e.g., MAC addresses) for one or more client devices 104-110 that are in P2P network group 100 to which group owner mobile device 102 belongs. Group owner mobile device 102 may transmit the signal to the AP from which the request was received at operation 508.

At operation 514, the AP of WLAN 200 that received a signal from group owner mobile device 102 at operation 512 may transmit information including identifiers for client mobile devices 104-110 in P2P network group 100 to server 302.

It will be recognized that alternative approaches may be used for sending client mobile device identifier information to server 302. For example, group owner mobile device 102 may broadcast a beacon signal including a P2P IE extended to include identification information (e.g., MAC addresses) for group owner mobile device 102 and one or more client mobile devices 104-110. One or more APs 202-208 of WLAN 200 may receive the beacon signal broadcast by group owner mobile device 102 and provide the information to server 302. Furthermore, it is recognized that operations similar to those illustrated in FIG. 5 could apply to providing distances between the group owner mobile device and client mobile devices to a server. In one such example, operation 508 may include server 302 transmitting to WLAN 200 a request for distances between client mobile devices associated with group owner mobile device 102.

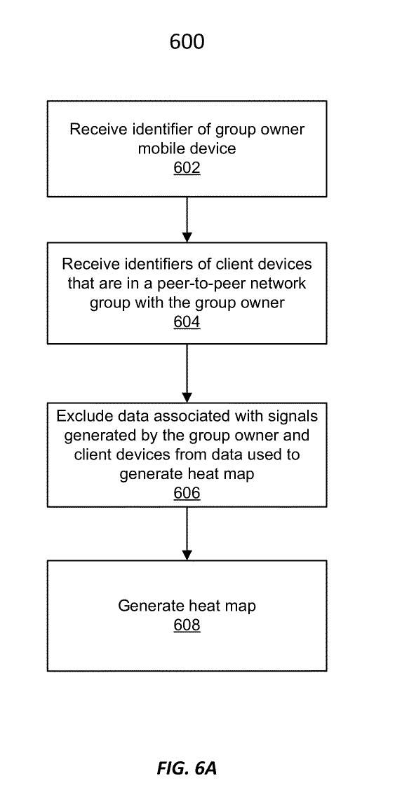

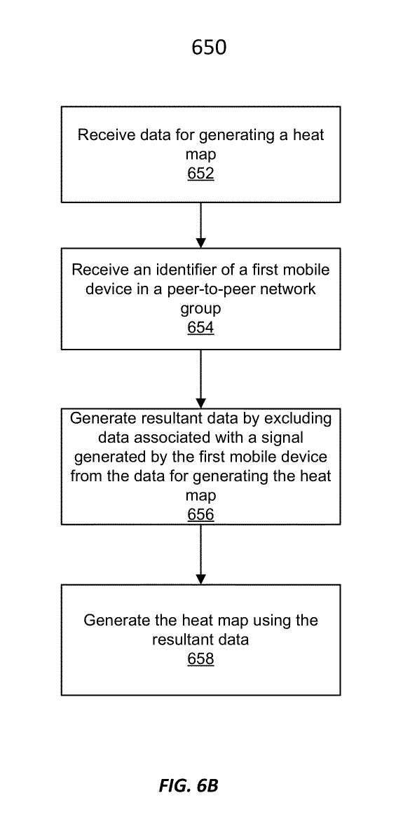

FIG. 6A illustrates a flow 600 for excluding data associated with mobile P2P network signal sources from a heat map, according to an embodiment of the present disclosure.

At operation 602, a server may receive an identifier of a group owner mobile device. For example, the server may receive an identifier that was broadcast by the group owner mobile device. The broadcast from the group owner mobile device may be received by an AP of a WLAN and transmitted from the AP of the WLAN to the server. The group owner mobile device may be a group owner of a P2P network group including one or more client mobile devices 104-110.

In an alternative embodiment, the group owner mobile device may be a group owner of a P2P network group that does not include any client mobile devices (e.g., when the group owner mobile device has autonomously created the P2P network group 100).

At optional operation 604, the server may receive identifiers of the one or more client mobile devices that are in the P2P network group with the group owner mobile device. The server may receive the client mobile device identifiers in a broadcast as discussed with regard to operation 602. Alternatively, the server may request client mobile device identifiers as discussed with regard to FIG. 5.

At operation 606, the server may exclude position data associated with signals generated by the group owner mobile device from data used by the server to generate a heat map. Optionally, the server may additionally exclude position data associated with signals generated by the one or more client mobile devices from inclusion in a heat map generated by the server. For example, the server may store a flag in association with the identifier for the group owner mobile device indicating that position data associated with a signal generated by the group owner mobile device is not to be used for heat map generation. The server 302 may additionally store flags in association with the identifiers for the client mobile devices indicating that position data associated with signals generated by the client mobile devices are not to be used for heat map generation.

At operation 608, the server may generate a heat map. Because of the operations performed by the server at operation 606, data associated with signals generated by the mobile devices in the P2P network group are excluded from the heat map.

FIG. 6B illustrates a flow 650 for excluding data associated with mobile P2P network signal sources from a heat map, according to another embodiment of the present disclosure.

At operation 652, a server may receive data for generating a heat map. The data received by the server for generating the heat map may include the strength of signals generated by access points and mobile devices as measured (or otherwise determined) at multiple locations associated with an environment. The data for generating the heat map may be collected using different techniques as described above with respect to FIGS. 4A and 4B.

At operation 654, the server may receive an identifier of a first mobile device. For example, the server may receive an identifier that is broadcast by a group owner mobile device. The broadcast from the group owner mobile device may be received by an AP of a WLAN and transmitted from the AP of the WLAN to the server. The group owner mobile device may be a group owner of a P2P network group including one or more client mobile devices. In an alternative embodiment, the group owner mobile device may be a group owner of a P2P network group that does not include any client mobile devices (e.g., when the group owner mobile device has autonomously created a P2P network group).

The first mobile device may be the group owner mobile device. The first mobile device may also be a client mobile device in the P2P network group. The server may receive the client mobile device identifier in a broadcast as described above, or otherwise without requesting the client mobile device identifier. Alternatively, the server may request the client mobile device identifier as described above with regard to FIG. 5.

At operation 656, the server may generate resultant data by excluding data associated with signals generated by the first mobile device from data used by the server to generate the heat map. For example, the server may store a flag in association with the identifier for the first mobile device indicating that data associated with a signal generated by the first mobile device is not to be used for heat map generation.

At operation 658, the server may generate the heat map using the resultant data, which does not include data associated with signals generated by the first mobile device in the P2P network group.

In some embodiments, when the server is tracking multiple mobile devices in the P2P network group, it may be desirable for the server to assign a determined position of a group owner mobile device to be the position of one or more client mobile devices in the P2P network group, particularly if the distance between the group owner mobile device and a client mobile device is relatively small. In this way, the server can reduce the processing time involved in determining the positions of mobile devices. When a server is tracking mobile devices in an environment where a large number of devices are in use, the processing savings may be substantial. Additionally, power and data consumed by the client mobile devices for gathering positioning data and transmitting positioning data to the server can be reduced. When the distance between the group owner mobile device and a client mobile device is relatively large, it may be desirable for the server to determine a position for the client mobile device.

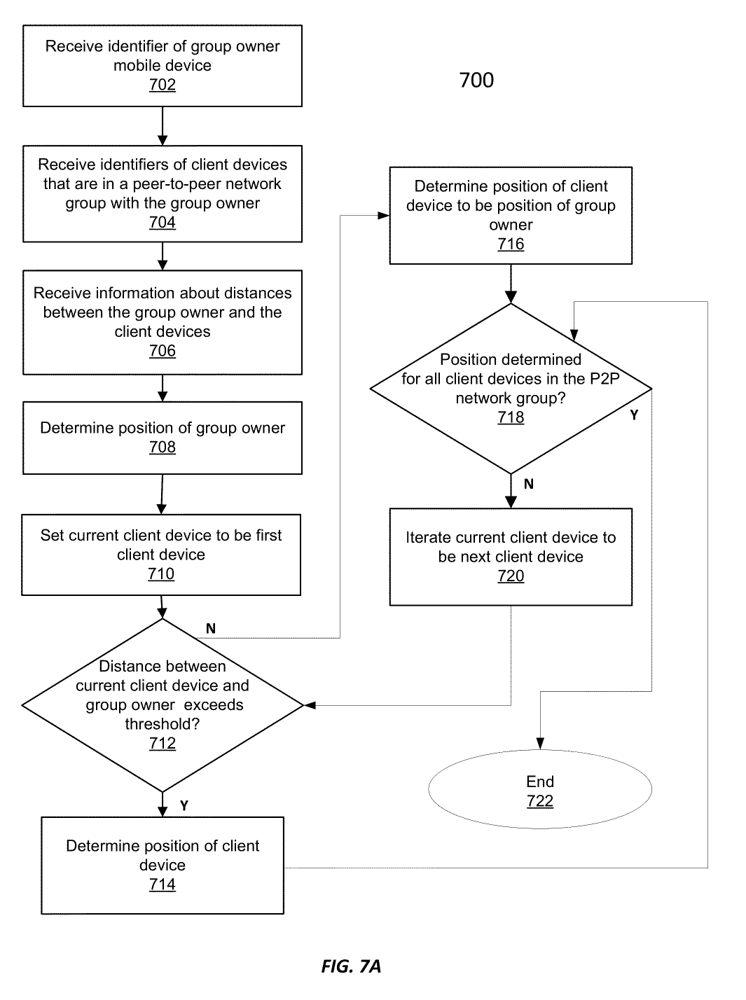

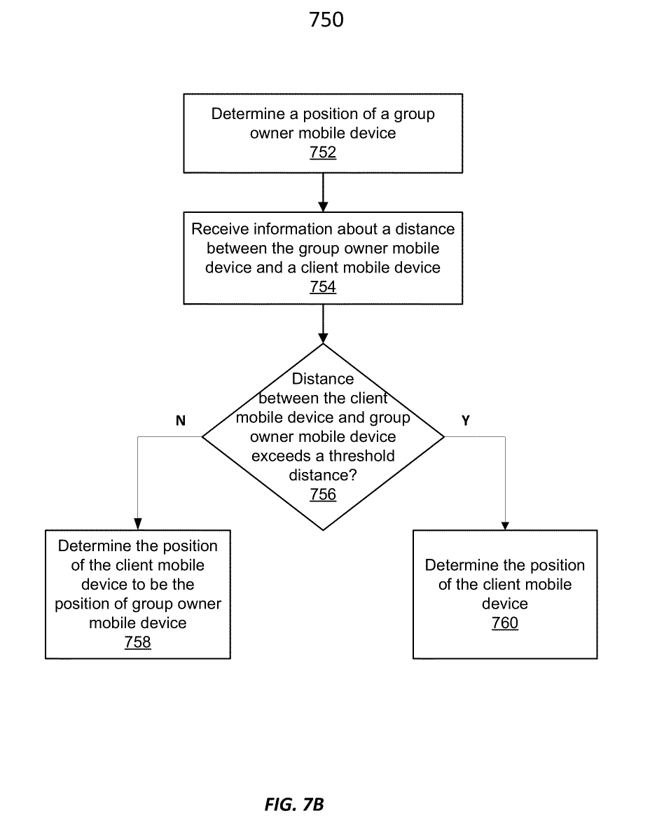

FIG. 7A illustrates a flow 700 for determining positions of mobile devices in a P2P network group, according to an embodiment.

At operation 702, a server may receive an identifier of a group owner mobile device. For example, the server may receive an identifier that was broadcast by the group owner mobile device. The broadcast from the group owner mobile device may be received by an AP of a WLAN and transmitted from the AP of the WLAN to a server. The group owner mobile device may be a group owner of a P2P network group including one or more client mobile devices.

At operation 704, the server may receive identifiers of the one or more client mobile devices that are in the P2P network group with the group owner mobile device. The server may receive the client mobile device identifiers in the broadcast discussed with regard to operation 702. Alternatively, the server may request client mobile device identifiers as discussed with regard to FIG. 5.

At operation 706, the server may receive information regarding distances between the group owner mobile device and the client mobile devices that are in the P2P network group with the group owner mobile device. The server may receive the distances in the broadcast discussed with regard to operation 702. For example, the group owner mobile device may broadcast a beacon signal including an extended P2P IE that includes identification information for the group owner mobile device, identification information for the one or more client mobile devices, and distances between the group owner mobile device and the one or more client mobile devices. Alternatively, the server may request distances between the group owner mobile device and the one or more client mobile devices in a manner similar to the operations discussed with regard to FIG. 5.

At operation 708, the server may determine a position of the group owner mobile device. For example, the server may receive position data from APs of the WLAN that determine RTTs for the group owner mobile device. In an alternative example, the server may receive position data from the group owner mobile device that measures RSSIs for multiple APs. The server may use the position data to determine a position of the group owner mobile device. In some embodiments, the server may obtain a heat map, and determine the position of the group owner mobile device using the heat map. The server may obtain the heat map by generating the heat map using methods described above, or by accessing a pre-generated heat map from a database or other storage devices. The server may also obtain a heat map by generating the heat map or accessing a database or other storage devices, and send the heat map to the group owner mobile device, in response to a request from the group owner mobile device. The server may compare the position data to the heat map that provides expected signal strengths for multiple APs at various positions in an environment. Using the heat map and the position data, the server may determine the location of the group owner mobile device, for example, using pattern matching or another analysis technique. For example, pattern matching may include finding location coordinates at which RSSIs for the multiple APs as determined from a heat map most closely match the RSSIs observed by the group owner mobile device. Alternatively, the group owner mobile device may use the heat map received from the server to determine the position of the group owner mobile device, for example, using pattern matching or other analysis techniques. Optionally, the group owner mobile device may report the position it determined to the server.

At operation 710, the server may set a variable representing a current device to a first client device of an ordered set of client devices.

At operation 712, the server may determine whether a distance between the current device and the group owner mobile device exceeds a threshold distance. The threshold distance may be, for example, a threshold distance in a range of 5 m to 100 m, such as a threshold distance in a range of 10 m to 75 m, for example, a threshold distance of 30 m. The threshold distance may be determined based on an accuracy for determining the location of the client mobile device. For example, if the location of the client mobile device is to be determined with an accuracy of 10 m, the threshold distance can be determined based on this accuracy to be 10 m, or greater or less than 10 m. If the distance exceeds the threshold, flow 700 may proceed to operation 714. If the distance does not exceed the threshold, flow 700 may proceed to operation 716.

In various embodiments, the group owner mobile device may regularly check the distances between the group owner mobile device and its client mobile devices. The group owner mobile device may send regular updates to the server with a list of distances between the group owner mobile device and its client mobile devices, and the server may determine whether the threshold distance is exceeded or not for a client mobile device. Additionally or alternatively, the group owner mobile device may determine whether a distance between the group owner mobile device and a client mobile device exceeds the threshold distance, and notify the server upon a determination that the distance between the group owner mobile device and a client mobile device exceeds the threshold distance. Flow 700 may then proceed to operation 714 when the server receives the notification from the group owner mobile device.

At operation 714, the server may determine a position of the current client mobile device. For example, the server may receive position data from APs of the WLAN that determine RTTs for the current client mobile device. In an alternative example, the server may receive position data from the current client mobile device that measures RSSIs for multiple APs. The server 302 may use the position data to determine a position of the current client mobile device.

At operation 716, the server may assign the position determined for the group owner mobile device to be the position of the current client mobile device.

At operation 718, the server may determine whether a position has been determined for all client mobile devices in the P2P network group. If a position has not been determined for each client mobile device in the P2P network group, flow 700 may proceed to operation 720. If a position has been determined for each client mobile device in the P2P network group, flow 700 may end as indicated at operation 722.

At operation 720, the server may iterate the variable representing the current device to a second client mobile device of the ordered set of client mobile devices. Operations 712-714, or 712 and 716-718 may be performed for the second client mobile device and performed for additional client mobile devices until positions have been determined for all of the client mobile devices in the P2P network group.

In some embodiments, a group owner mobile device may determine a position of a client mobile device to be the same as the position of the group owner mobile device, e.g., when the client mobile device is relatively close to the group owner device. The group owner mobile device may determine whether a distance between the client mobile device and the group owner mobile device exceeds a threshold distance. The threshold distance may be a threshold distance as described above. Based on a determination that the distance between the client mobile device and the group owner mobile device does not exceed the threshold distance, the group owner mobile device may determine a position of the client mobile device using position data received by the group owner mobile device. The group owner mobile device may transmit the determined position of the client mobile device to the client device and/or to a server.

In some embodiments, a client mobile device may determine whether a distance between the client mobile device and a group owner mobile device exceeds a threshold distance. The threshold distance may be a threshold distance as described above. Based on a determination that the distance between the client mobile device and the group owner mobile device exceeds the threshold distance, the client mobile device may use position data received by the client mobile device to determine a position of the client mobile device. Based on a determination that the distance between the client mobile device and the group owner mobile device does not exceed the threshold distance, the client mobile device may determine a position of the client mobile device using position data received from the group owner mobile device.

FIG. 7B illustrates a flow 750 for determining a position of a mobile device in a P2P network group by a server, according to an embodiment of the present disclosure.

At operation 752, the server determines a position of a group owner mobile device of the P2P network group. As described above, the group owner mobile device may support at least one of communications between devices within the P2P network group or communications between a device within the P2P network group and devices outside of the P2P network group. In some embodiments, the server may receive position data from APs of a WLAN that determine RTTs for the group owner mobile device. In some embodiments, the server may receive position data from the group owner mobile device that measures RSSIs for multiple APs. The server may use the position data to determine a position of the group owner mobile device. In some embodiments, the server may use a heat map to determine the position of the group owner mobile device as described above with respect to operation 708.

At operation 754, the server may receive information about a distance between the group owner mobile device and the client mobile device that is in the P2P network group with the group owner mobile device. The server may receive the information about the distance in a broadcast as described above with regard to operations 702 and 706. For example, the group owner mobile device may broadcast a beacon signal including an extended P2P IE that includes identification information for the group owner mobile device, identification information for the one or more client mobile devices, and distances between the group owner mobile device and the one or more client mobile devices. Alternatively, the server may request distances between the group owner mobile device and the one or more client mobile devices in a manner similar to the operations described above with regard to FIG. 5.

At operation 756, the server may determine whether a distance between the client mobile device and the group owner mobile device exceeds a threshold distance. The threshold distance may be, for example, a threshold distance in a range of 5 m to 100 m, such as a threshold distance in a range of 10 m to 75 m, for example, a threshold distance of 30 m. The threshold distance may be determined based on an accuracy for determining the location of the client mobile device. For example, if the location of the client mobile device is to be determined with an accuracy of 10 m, the threshold distance can be determined based on this accuracy to be 10 m, or greater or less than 10 m.

If the distance between the client mobile device and the group owner mobile device does not exceed the threshold distance, flow 750 may proceed to operation 758, where the server may assign the determined position of the group owner mobile device to be the position of the client mobile device.

If the distance between the client mobile device and the group owner mobile device exceeds the threshold distance, flow 750 may proceed to operation 760, where the server may determine the position of the client mobile device using various methods as described above with respect to operation 714. For example, the server may receive position data from APs of a WLAN that determine RTTs for the client mobile device. In an alternative example, the server may receive position data from the client mobile device that measures RSSIs for multiple APs. The server may use the position data to determine a position of the client mobile device. In some embodiments, the server may obtain a heat map, and determine the position of the client mobile device using the heat map in a way similar to the one described above at operations 708 and 752. The server may obtain the heat map by generating the heat map using methods described above, or by accessing a pre-generated heat map from a database or other storage devices. The server may also obtain a heat map by generating the heat map or accessing a database or other storage devices, and send the heat map to the client mobile device, in response to a request from the client mobile device. The client mobile device may then use the heat map received from the server to determine the position of the client mobile device, for example, using pattern matching or other analysis techniques. Optionally, the client mobile device may report the position it determined to the server.

In various embodiments, the group owner mobile device may regularly check the distances between the group owner mobile device and its client mobile devices. The group owner mobile device may send regular updates to the server with of a list of distances between the group owner mobile device and its client mobile devices, and the server may determine whether the threshold distance is exceeded or not for a client mobile device. Additionally or alternatively, the group owner mobile device may determine whether a distance between the group owner mobile device and a client mobile device exceeds the threshold distance, and notify the server upon a determination that the distance between the group owner mobile device and a client mobile device exceeds the threshold distance. The server may then proceed to operation 760 after receiving the notification from the group owner mobile device.

FIG. 8 illustrates an example of a computer system 800 in which one or more embodiments may be implemented. A computer system as illustrated in FIG. 8 may be incorporated as a part of the previously described computing devices. For example, computer system 800 can represent some of the components of mobile devices 102-110, APs 202-208 and/or server 302 in FIGS. 1-5. Computer system 800 may further store and/or execute various application modules described herein.

FIG. 8 provides a block diagram of one embodiment of computer system 800 that can perform the methods provided by various other embodiments, as described herein, and/or can function as a host computer system, a remote kiosk/terminal, a point-of-sale device, a mobile device, and/or a computer system. FIG. 8 is meant only to provide a generalized illustration of various components, any or all of which may be utilized as appropriate. FIG. 8, therefore, broadly illustrates how individual system elements may be implemented in a relatively separated or relatively more integrated manner.

Computer system 800 is shown comprising hardware elements that can be electrically coupled via a bus 802 (or may otherwise be in communication, as appropriate). The hardware elements may include one or more processors 804, including without limitation one or more general-purpose processors and/or one or more special-purpose processors (such as digital signal processing chips, graphics acceleration processors, and/or the like); one or more input devices 806, which can include without limitation a mouse, a keyboard and/or the like; and one or more output devices 808, which can include without limitation a display device, a printer and/or the like.

Computer system 800 may further include (and/or be in communication with) one or more non-transitory storage devices 810, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

Computer system 800 might also include a communications subsystem 812, which can include without limitation a modem, a network card (wireless or wired), an infrared communication device, a wireless communication device and/or chipset (such as a Bluetooth® device, an 802.11 device, a Wi-Fi device, a WiMax device, cellular communication facilities, etc.), and/or similar communication interfaces. Computing system 800 may include one or more antennas for wireless communication as part of communications subsystem 812 or as a separate component coupled to any portion of the system. Communications subsystem 812 may permit data to be exchanged with a network (such as the network described below), other computer systems, and/or any other devices described herein. Communication subsystem 812 may include one or more of a means for receiving data for generating a heat map, a means for receiving broadcast data, a means for requesting identifiers of mobile devices, a means for receiving the identifiers of the mobile devices, a means for receiving information about a distance between a group owner device and a client mobile device, a means for receiving RTT data, or a means for receiving RSSI data. In many embodiments, computer system 800 may further comprise a non-transitory working memory 814, which can include a RAM or ROM device, as described above.

Computer system 800 also can comprise software elements, shown as being currently located within working memory 814, including an operating system 816, device drivers, executable libraries, and/or other code, such as one or more applications 818, which may comprise computer programs provided by various embodiments, and/or may be designed to implement methods, and/or configure systems, provided by other embodiments, as described herein. Merely by way of example, one or more procedures and/or modules described with respect to the method(s) discussed above may be implemented as code and/or instructions executable by a computer (and/or a processor within a computer); in an aspect, such code and/or instructions can be used to configure and/or adapt a general purpose computer (or other device) to perform one or more operations in accordance with the described methods.

A set of these instructions and/or code might be stored on a computer-readable storage medium, such as storage device(s) 810 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by computer system 800 and/or might take the form of source and/or installable code, which, upon compilation and/or installation on computer system 800 (e.g., using any of a variety of generally available compilers, installation programs, compression/decompression utilities, etc.), may take the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a system configured to provide some or all of the features described herein can comprise hardware and/or software that is specialized (e.g., an application-specific integrated circuit (ASIC), a software method, etc.) or generic (e.g., processor(s) 804, applications 818, etc.) Further, connection to other computing devices such as network input/output devices may be employed.

Some embodiments may employ a computer system (such as computer system 800) to perform methods in accordance with the present disclosure. For example, some or all of the procedures of the described methods may be performed by computer system 800 in response to processor 804 executing one or more sequences of one or more instructions (which might be incorporated into operating system 816 and/or other code, such as an application 818) contained in working memory 814. Such instructions may be read into working memory 814 from another computer-readable medium, such as one or more of storage device(s) 810. Merely by way of example, execution of the sequences of instructions contained in working memory 814 might cause processor(s) 804 to perform one or more procedures of the methods described herein. Processor(s) 804 and memory 814 may together comprise one or more of a means for excluding data associated with a signal generated by mobile devices, a means for generating the heat map, at least a part of a means for determining a position of a group owner mobile device or a client mobile device, a means for determining whether the distance between the group owner mobile device and the client mobile device exceeds a threshold distance, at least a part of a means for generating the heat map, or a means for determining the position of the group owner device or the client mobile device using a heat map.

The terms “machine-readable medium” and “computer-readable medium,” as used herein, refer to any medium that participates in providing data that causes a machine to operate in a specific fashion. In an embodiment implemented using computer system 800, various computer-readable media might be involved in providing instructions/code to processor(s) 804 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as storage device(s) 810. Volatile media include, without limitation, dynamic memory, such as working memory 814. Transmission media include, without limitation, coaxial cables, copper wire and fiber optics, including the wires that comprise bus 802, as well as the various components of communications subsystem 812 (and/or the media by which communications subsystem 812 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to processor(s) 804 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 800. These signals, which might be in the form of electromagnetic signals, acoustic signals, optical signals and/or the like, are all examples of carrier waves on which instructions can be encoded, in accordance with various embodiments of the invention.

Communications subsystem 812 (and/or components thereof) generally will receive the signals, and bus 802 then might carry the signals (and/or the data, instructions, etc. carried by the signals) to working memory 814, from which processor(s) 804 retrieves and executes the instructions. The instructions received by working memory 814 may optionally be stored on a non-transitory storage device 810 either before or after execution by processor(s) 804.

FIG. 9 illustrates an example of a mobile device 900, according to some embodiments. Mobile device 900 includes a processor 910, and a memory 920. Mobile device 900 may use processor 910 configured to execute instructions for performing operations at a number of components and can be, for example, a general-purpose processor or microprocessor suitable for implementation within a portable electronic device. Processor 910 is communicatively coupled with a plurality of components within mobile device 900. To realize this communicative coupling, processor 910 may communicate with the other illustrated components across a bus 940. Bus 940 can be any subsystem adapted to transfer data within mobile device 900. Bus 940 can be a plurality of computer buses and include additional circuitry to transfer data.

Memory 920 may be coupled to processor 910. In some embodiments, memory 920 offers both short-term and long-term storage and may be divided into several units. Memory 920 may be volatile, such as static random access memory (SRAM) and/or dynamic random access memory (DRAM) and/or non-volatile, such as read-only memory (ROM), flash memory, and the like. Furthermore, memory 920 can include removable storage devices, such as secure digital (SD) cards. Thus, memory 920 provides storage of computer readable instructions, data structures, program modules, and other data for mobile device 900. In some embodiments, memory 920 may be distributed into different hardware modules.

In some embodiments, memory 920 stores a plurality of application modules 921 through 922, which may be any number of applications. Application modules contain particular instructions to be executed by processor 910. In alternative embodiments, other hardware modules 901 may additionally execute certain applications or parts of application modules 921-922. In certain embodiments, memory 920 may additionally include secure memory, which may include additional security controls to prevent copying or other unauthorized access to secure information.

In some embodiments, memory 920 includes an operating system 923. Operating system 923 may be operable to initiate the execution of the instructions provided by application modules 921-922 and/or manage other hardware modules 901 as well as interfaces with communication modules which may use a wireless transceiver 912. Operating system 923 may be adapted to perform other operations across the components of mobile device 900 including threading, resource management, data storage control and other similar functionality.

In some embodiments, mobile device 900 includes a plurality of other hardware modules 901. Each of other hardware modules 901 is a physical module within mobile device 900. However, while each of hardware modules 901 is permanently configured as a structure, a respective one of hardware modules 901 may be temporarily configured to perform specific functions or temporarily activated. A common example is an application module that may program a camera module (i.e., hardware module) for shutter release and image capture. A respective one of hardware modules 901 can be, for example, an accelerometer 930, a Wi-Fi transceiver, a satellite navigation system receiver (e.g., a global positioning system (GPS) module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of hardware modules 901-902 may be implemented in software.

Mobile device 900 may include a component such as a wireless communication module which may integrate an antenna 914 and wireless transceiver 912 with any other hardware, firmware, or software necessary for wireless communications. Such a wireless communication module may be configured to receive signals from various devices such data sources via networks, access points and the like. The wireless communication module may include a means for transmitting or receiving data, such as identifiers of mobile devices, position data, a heat map, or information about distances. The wireless communication module, processor 910 and memory 920 may together comprise at least a part of one or more of a means for generating a heat map or a means for determining a position of a group owner mobile device or a client mobile device.

In addition to other hardware modules 901 and application modules 921-922, mobile device 900 may include a display module 903 and a user input module 904. Display module 903 graphically presents information from mobile device 900 to the user. This information may be derived from one or more application modules 921-922, one or more hardware modules 901, a combination thereof, or any other suitable means for resolving graphical content for the user (e.g., by operating system 923). Display module 903 can be liquid crystal display (LCD) technology, light emitting polymer display (LPD) technology, or some other display technology. In some embodiments, display module 903 is a capacitive or resistive touch screen and may be sensitive to haptic and/or tactile contact with a user. In such embodiments, display module 903 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for generating a heat map, the method comprising:
receiving data for generating the heat map;
receiving an identifier of a first mobile device in a peer-to-peer network group;
in response to receiving the identifier of the first mobile device, generating resultant data by excluding data associated with a signal generated by the first mobile device from the data for generating the heat map; and
generating the heat map using the resultant data.

2. The method of claim 1, wherein the first mobile device is a group owner of the peer-to-peer network group, the group owner supporting at least one of communications between devices within the peer-to-peer network group or communications between a device within the peer-to-peer network group and devices outside of the peer-to-peer network group.

3. The method of claim 2, wherein the group owner serves as an access point for the peer-to-peer network group.

4. The method of claim 1, wherein the identifier of the first mobile device is included in a broadcast data from the first mobile device.

5. The method of claim 4, wherein at least a part of the identifier of the first mobile device is included in a peer-to-peer network information element of the broadcast data from the first mobile device.

6. The method of claim 1, wherein the identifier of the first mobile device includes a media access control (MAC) address.

7. The method of claim 1, further comprising:
receiving an identifier of a second mobile device in the peer-to-peer network group; and
in response to receiving the identifier of the second mobile device, generating the resultant data by excluding data associated with a signal generated by the second mobile device from the data for generating the heat map.

8. The method of claim 7, further comprising:
requesting the identifier of the second mobile device from the first mobile device; and
wherein receiving the identifier of the second mobile device includes receiving data from the first mobile device including the identifier of the second mobile device.

9. The method of claim 7, wherein receiving the identifier of the second mobile device includes receiving the identifier of the second mobile device from the first mobile device without a request.

10. The method of claim 7, wherein the identifier of the second mobile device includes a media access control (MAC) address.

11. The method of claim 1, wherein the data for generating the heat map includes data associated with signals generated by a plurality of access points, the data being determined for a plurality of locations in an environment.

12. The method of claim 1, wherein the data for generating the heat map includes received signal strength indicator (RSSI) data or round trip time (RTT) data.

13. A server comprising:
a processor; and
a computer readable storage device communicatively coupled to the processor, wherein the computer readable storage device stores one or more programs executable by the processor, the one or more programs including instructions for:
receiving data for generating a heat map;
receiving an identifier of a first mobile device in a peer-to-peer network group;
in response to receiving the identifier of the first mobile device, generating resultant data by excluding data associated with a signal generated by the first mobile device from the data for generating the heat map; and
generating the heat map using the resultant data.

14. The server of claim 13, wherein the first mobile device is a group owner of the peer-to-peer network group, the group owner supporting at least one of communications between devices within the peer-to-peer network group or communications between a device within the peer-to-peer network group and devices outside of the peer-to-peer network group.

15. The server of claim 13, wherein the identifier of the first mobile device is included in a broadcast data from the first mobile device.

16. The server of claim 13, wherein the one or more programs further include instructions for:
receiving an identifier of a second mobile device in the peer-to-peer network group; and
in response to receiving the identifier of the second mobile device, generating the resultant data by excluding data associated with a signal generated by the second mobile device from the data for generating the heat map.

17. The server of claim 16, wherein the one or more programs further include instructions for:
requesting the identifier of the second mobile device from the first mobile device; and
wherein receiving the identifier of the second mobile device includes receiving data from the first mobile device including the identifier of the second mobile device.

18. The server of claim 16, wherein receiving the identifier of the second mobile device includes receiving the identifier of the second mobile device from the first mobile device without a request.

19. The server of claim 13, wherein the data for generating the heat map includes received signal strength indicator (RSSI) data or round trip time (RTT) data.

20. A non-transitory computer readable medium including machine-readable instructions stored thereon for generating a heat map, the instructions comprising:
receiving data for generating the heat map;
receiving an identifier of a first mobile device in a peer-to-peer network group;
in response to receiving the identifier of the first mobile device, generating resultant data by excluding data associated with a signal generated by the first mobile device from the data for generating the heat map; and
generating the heat map using the resultant data.

21. The non-transitory computer readable medium of claim 20, wherein the first mobile device is a group owner of the peer-to-peer network group, the group owner supporting at least one of communications between devices within the peer-to-peer network group or communications between a device within the peer-to-peer network group and devices outside of the peer-to-peer network group.

22. The non-transitory computer readable medium of claim 20, wherein the instructions further comprise:
receiving an identifier of a second mobile device in the peer-to-peer network group; and
in response to receiving the identifier of the second mobile device, generating the resultant data by excluding data associated with a signal generated by the second mobile device from the data for generating the heat map.

23. An apparatus for generating a heat map, comprising:
means for receiving data for generating the heat map;
means for receiving an identifier of a first mobile device in a peer-to-peer network group;
means for, in response to receiving the identifier of the first mobile device, generating resultant data by excluding data associated with a signal generated by the first mobile device from the data for generating the heat map; and
means for generating the heat map using the resultant data.

24. The apparatus of claim 23, wherein the first mobile device is a group owner of the peer-to-peer network group, the group owner supporting at least one of communications between devices within the peer-to-peer network group or communications between a device within the peer-to-peer network group and devices outside of the peer-to-peer network group.

25. The apparatus of claim 23, wherein the identifier of the first mobile device is included in a broadcast data from the first mobile device.

26. The apparatus of claim 23, further comprising:
means for receiving an identifier of a second mobile device in the peer-to-peer network group; and
means for, in response to receiving the identifier of the second mobile device, generating the resultant data by excluding data associated with a signal generated by the second mobile device from the data for generating the heat map.

27. The apparatus of claim 26, further comprising:
means for requesting the identifier of the second mobile device from the first mobile device; and
wherein the means for receiving the identifier of the second mobile device includes means for receiving data from the first mobile device including the identifier of the second mobile device.

28. The apparatus of claim 26, wherein the means for receiving the identifier of the second mobile device includes means for receiving the identifier of the second mobile device from the first mobile device without a request.

29. The apparatus of claim 23, wherein the data for generating the heat map includes data associated with signals generated by a plurality of access points, the data being determined for a plurality of locations in an environment.

30. The apparatus of claim 23, wherein the data for generating the heat map includes received signal strength indicator (RSSI) data or round trip time (RTT) data.
